(19) United States
(12) Patent Application Publication
(10) Pub. No.: US 2024/0250290 A1
(43) Pub. Date: Jul. 25, 2024

(54) ALL-SOLID-STATE BATTERY HAVING UNIFORM INTERFACES BETWEEN ELECTRODES AND SOLID ELECTROLYTE LAYER

(71) Applicants: Hyundai Motor Company, Seoul (KR); Kia Corporation, Seoul (KR)

(72) Inventors: Tae Young Kwon, Daegu (KR); Yong Hun Lee, Hwaseong (KR); Ju Min Kim, Hwaseong (KR); Jong Hwan Choi, Hwaseong (KR)

(21) Appl. No.: 18/231,010

(22) Filed: Aug. 7, 2023

(30) Foreign Application Priority Data
Jan. 20, 2023 (KR) 10-2023-0008543

(51) Int. Cl. H01M 10/0562

(52) U.S. Cl. CPC H01M 10/0562; H01M 2300/008

(57) ABSTRACT

Disclosed is an all-solid-state battery having uniform interfaces between electrodes and a solid electrolyte layer.

### CROSS-REFERENCE TO RELATED APPLICATION

This application claims under 35 U.S.C. § 119(a) the benefit of priority to Korean Patent Application No. 10-2023-0008543 filed on Jan. 20, 2023, the entire contents of which are incorporated herein by reference.

### TECHNICAL FIELD

The disclosure relates to an all-solid-state battery having uniform interfaces between electrodes and a solid electrolyte layer and a vehicle including the same.

### BACKGROUND

An all-solid-state battery is a three-layer laminate including a cathode, an anode, and a solid electrolyte layer located therebetween. All elements of the all-solid-state battery are solids, and interfaces between respective layers, the dispersion states of components in the elements, the stabilities of the respective layers, etc. have a great influence on cell characteristics.

The solid electrolyte layer has been manufactured by applying a slurry including a solid electrolyte, a binder, a dispersant, a solvent, etc. Pores or cracks may occur on the surface of the solid electrolyte or in the solid electrolyte depending on the dispersion state of solid particles in the slurry. For example, when the solid electrolyte is precipitated or condensed in the slurry, a part of the solid electrolyte layer, in which there is a small amount of the solid electrolyte, is formed, and, when the solid electrolyte layer is dried in this state, pores or cracks occur in this part of the solid electrolyte layer in which there is the small amount of the solid electrolyte.

When the pores or the cracks occur in the solid electrolyte layer, contact between the electrodes and the solid electrolyte layer becomes non-uniform, and thereby, current density may be partially concentrated, interfacial resistance may be increased, and thus cell performance may be reduced. Further, safety may be reduced due to growth of lithium dendrites.

The above information disclosed in this Background section is only for enhancement of understanding of the background of the invention and therefore it may contain information that does not form the prior art that is already known in this country to a person of ordinary skill in the art.

### SUMMARY

In preferred aspects, provided are an all-solid-state battery having uniform interfaces between a solid electrolyte layer and electrodes and a vehicle including the all-solid-state battery.

A term “all-solid-state battery” as used herein refers to a rechargeable secondary battery that includes an electrolyte in a solid state, which may include electrolytic components for transferring ions between the electrodes of the battery.

In one aspect, provided is an all-solid-state battery including a first electrode, a second electrode, and a solid electrolyte layer located between the first electrode and the second electrode.

The solid electrolyte layer includes a first layer located on a side of the first electrode, and including a first solid electrolyte, and a second layer located on a side of the second electrode, and including a second solid electrolyte.

The first layer may be formed by applying a first electrolyte composition including the first solid electrolyte, a first binder, a first dispersant, and a first solvent.

The first solid electrolyte may include a sulfide-based solid electrolyte.

The first binder may include one or more selected from the group consisting of nitrile butadiene rubber (NBR), hydrogenated nitrile butadiene rubber (HNBR), styrene butadiene rubber (SBR), butadiene rubber (BR), polyvinylidene fluoride (PVDF), and polytetraluoroethylene (PTFE).

The first dispersant may include one or more selected from the group consisting of carboxymethyl cellulose, carboxyethyl cellulose, and polypropylene glycol.

The first solvent may include one or more selected from the group consisting of N-methyl-2-pyrrolidone (NMP), butyl butyrate, pentyl butyrate, hexyl butyrate, and heptyl butyrate.

The first electrolyte composition may have a solid content of about 40% to 70%.

The first electrolyte composition may have a turbiscan stability index (TSI) of 1 or less when the first electrolyte composition is left unattended for 48 hours.

The first electrolyte composition may satisfy Requirement 1 below.

$$1 \leq \vert \frac{a}{b} \vert \qquad [ Requirement 1 ]$$

In Requirement 1, a may be a maximum value of variations of backscattering (ΔBS) in an area configured such that a scan height is in a range of 0% to 49%, as results of measurement of intensities of transmitted light and the scattered light by radiating near infrared light having a 5 wavelength of 880 nm to the first electrolyte composition left unattended for 48 hours, and b may be a maximum value of variations of backscattering (ΔBS) in an area configured such that the scan height is in a range of 51% to 100%, as the results of measurement of the intensities of the transmitted light and the scattered light by radiating the near infrared light having the wavelength of 880 nm to the first electrolyte composition left unattended for 48 hours.

The second layer may be formed by applying a second electrolyte composition including the second solid electrolyte, a second binder, a second dispersant, and a second solvent.

The second solid electrolyte may include a sulfide-based solid electrolyte.

The second binder may include one or more selected from the group consisting of nitrile butadiene rubber (NBR), hydrogenated nitrile butadiene rubber (HNBR), styrene butadiene rubber (SBR), butadiene rubber (BR), polyvinylidene fluoride (PVDF), and polytetrafluoroethylene (PTFE).

The second dispersant may include one selected from the group consisting of carboxymethyl cellulose, carboxyethyl cellulose, and polypropylene glycol.

The second solvent may include one or more selected from the group consisting of N-methyl-2-pyrrolidone (NMP), butyl butyrate, pentyl butyrate, hexyl butyrate, and heptyl butyrate.

The second electrolyte composition may have a solid content of about 40% to 70%.

The second electrolyte composition may have a turbiscan stability index (TSI) of about 1 or less when the second electrolyte composition is left unattended for 48 hours.

The second electrolyte composition may satisfy Requirement 2 below.

$$\vert \frac{c}{d} \vert < 1 \qquad [ Requirement 2 ]$$

In Requirement 2, c may be a maximum value of variations of backcattering (ΔBS) in an area configured such that a scan height is in a range of 0% to 49%, as results of measurement of intensities of transmitted light and the scattered light by radiating near infrared light having a wavelength of 880 nm to the second electrolyte composition left unattended for 48 hours, and d may be a maximum value of variations of backscattering (ΔBS) in an area configured such that the scan height is in a range of 51% to 100%, as the results of measurement of the intensities of the transmitted light and the scattered light by radiating the near infrared light having the 5 wavelength of 880 nm to the second electrolyte composition left unattended for 48 hours.

The first layer may include a first dispersant, the second layer may include a second dispersant, and a number average molecular weight of the first dispersant may be greater than a number average molecular weight of the second dispersant.

Also provided is a vehicle including the all-solid-state battery as described herein.

Other aspects of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 shows an exemplary all-solid-state battery according to an exemplary embodiment of the present disclosure;

FIG. 2 shows the result of analysis of a first electrolyte composition according to Manufacturing Example 1 using a turbiscan;

FIG. 3 shows the result of analysis of a second electrolyte composition according to Manufacturing Example 2 using the turbiscan;

FIG. 4 shows the result of analysis of the surface of a second layer according to Example using a scanning electron microscope;

FIG. 5 shows the result of analysis of the surface of an additional first layer according to Comparative Example using the scanning electron microscope;

FIG. 6 shows the capacity retentions of all-solid-state batteries according to Example and Comparative Example; and

FIG. 7 shows the Coulombic efficiencies of the all-solid-state batteries according to Example and Comparative Example.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the invention. Singular expressions may encompass plural expressions, unless they have clearly different contextual meanings.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

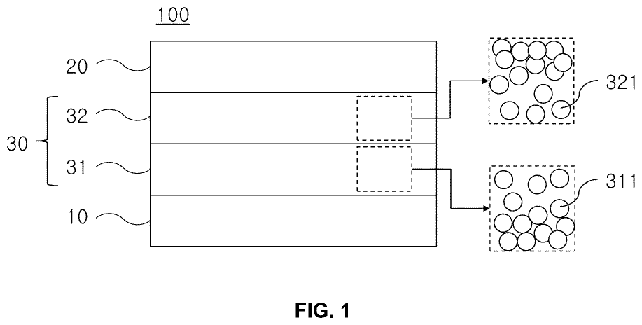

FIG. 1 shows an exemplary all-solid-state battery 100 according to an exemplary embodiment of the present disclosure. The all-solid-state battery 100 may include a first electrode 10, a second electrode 20, and a solid electrolyte layer 30 interposed between the first electrode 10 and the second electrode 20.

The first electrode 10 and the second electrode 20 may be electrodes having opposite polarities. For example, when the first electrode 10 is a cathode, the second electrode 20 may be an anode, and, when the first electrode 10 is an anode, the second electrode 20 may be a cathode.

Each of the first electrode 10 and the second electrode 20 may include an active material, a solid electrolyte, a binder, a conductive material, etc.

The active material may include a cathode active material or an anode active material.

The cathode active material may include a rock salt layer-type active material, such as LiCoO₂, LiMnO₂, LiNiO₂, LiVO₂ or Li₁₊ₓNi_{1/3}Co_{1/3}MnInO₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rock salt layer-type active material in which a part of a transition metal is substituted with a different kind of metal, such as LiNi_{0.8}Co_{(0.2-x)}AlₓO₂ (0<x<0.2), a spinel-type active material in which a part of a transition metal is substituted with a different kind of metal, such as Li₁₊ₓMn_{2-x-y}M_{y}O₄ (M being at least one of Al, Mg, Co, Fe, Ni or Zn, and 0<x+y<2), lithium titanate, such as Li₄Ti₅O₁₂, or the like.

The solid electrolyte may include an oxide-based solid electrolyte, a sulfide-based solid electrolyte, or a polymer electrolyte.

The oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), or the like.

The sulfide-based solid electrolyte may include Li₂S—P₂S₅, Li₂S—P₂S₅—LiI, Li₂S—P₂S₅—LiCl. Li₂S—P₂S₅—LiBr, Li—S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li₁₀GeP₂S₁₂, or the like.

The polymer electrolyte may include a gel polymer electrolyte, a solid polymer electrolyte, or the like.

The binder may include one or more selected from nitrile butadiene rubber (NBR), hydrogenated nitrile butadiene rubber (HNBR), styrene butadiene rubber (SBR), butadiene rubber (BR), polyvinylidene fluoride (PVDF), and polytetrafluoroethylene (PTFE).

The conductive material may include carbon black, conductive graphite, ethylene black, graphene, or the like.

The amounts of the active material, the solid electrolyte, the binder, the conductive material, etc. included in the first electrode 10 or the second electrode 20 are not limited to specific values, and may be properly adjusted depending on the desired capacity, efficiency, etc. of the all-solid-state battery 100.

The solid electrolyte layer 30 may include a first layer 31 disposed on the first electrode and including a first solid electrolyte 311, and a second layer 32 disposed on the second electrode 20 and including a second solid electrolyte 321. The meaning that the first layer 31 is disposed on the first electrode 10 or the second layer 32 is disposed on the second electrode 20 includes not only the case in which a target element comes into direct contact with the first electrode 10 or the second electrode 20 but also the case in which the target element is located in a corresponding direction but does not come into direct contact with the first electrode 10 or the second electrode 20.

As shown in FIG. 1, the first layer 31 is characterized in that the amount of the first solid electrolyte 311 in the interface between the first layer 31 and the first electrode 10 may be greater than the amount of the first solid electrolyte 311 in the interface between the first layer 31 and the second layer 32. Here, the amount of the first solid electrolyte 311 in the interface may include not only the amount of the first solid electrolyte 311 which forms a main surface of the first layer 31 but also the amount of the first solid electrolyte 311 included in a region up to a designated depth from the main surface of the first layer 31 in the thickness direction of the solid electrolyte layer 30. However, the designated depth may be less than about 50% of the thickness of the first layer 31.

Further, the second layer 32 is characterized in that the amount of the first solid electrolyte 321 in the interface between the second layer 32 and the second electrode 20 may be greater than the amount of the second solid electrolyte 321 in the interface between the second layer 32 and the first layer 31. Here, the amount of the second solid electrolyte 321 in the interface may include not only the amount of the second solid electrolyte 321 which forms a main surface of the second layer 32 but also the amount of the second solid electrolyte 321 included in a region up to a designated depth from the main surface of the second layer 32 in the thickness direction of the solid electrolyte layer 30. However, the designated depth may be less than about 50% of the thickness of the second layer 32.

As described above, in the all-solid-state battery 100 according to an exemplary embodiment of the present disclosure, a large amount of the solid electrolyte may be present on both main surfaces of the solid electrolyte layer 30, and thus, the surfaces of the solid electrolyte layer 30 may become even, and the interface between the solid electrolyte layer 30 and the first electrode 10 and the interface between the solid electrolyte layer 30 and the second electrode 20 may be uniformly formed.

The first layer 31 having the above-described distribution of the first solid electrolyte 311 may be formed by applying a first electrolyte composition in which the first solid electrolyte 311 is distributed to be mainly located in the lower region of first electrolyte composition. On the contrary, the second layer 32 having the above-described distribution of the second solid electrolyte 321 may be formed by applying a second electrolyte composition in which the second solid electrolyte 321 is distributed to be mainly located in the upper region of the second electrolyte composition. The distribution position of the first solid electrolyte 311 or the second solid electrolyte 321 may be adjusted depending on a combination of the first solid electrolyte 311 or the second solid electrolyte 321, a solvent, a dispersant, the binder, etc. For example, when a binder having a high molecular weight or a dispersant having a high molecular weight is used, a solid electrolyte may be mainly distributed in the lower region. Further, the distribution position of the first solid electrolyte 311 or the second solid electrolyte 321 may be adjusted through the density of the first solid electrolyte 311 or the second solid electrolyte 321, the density of the solvent, or the like. For example, when a material having a greater density than the solvent is used, the material may be mainly distributed in the lower region, and, when a material having a lower density than the solvent is used, the material may be mainly distributed in the upper region.

The first layer 31 may include the first solid electrolyte 311, a first binder, and a first dispersant. Concretely, the first layer 31 may include an amount of about 1 wt % to 10 wt % of the first binder, exemplary 0.1 wt % to 5 wt % of the first dispersant, and the balance of the first solid electrolyte 311, based on the total weight of the first layer 31.

The first electrolyte composition may include the first solid electrolyte 311, the first binder, the first dispersant, and a first solvent.

The first solid electrolyte 311 may include a sulfide-based solid electrolyte. The sulfide-based solid electrolyte may include Li₂S—P₂S₅, LiAS-P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiSr—LiBr, Li₂S—SiS₂—LiCl, Li₂S—SiS₂—B₂S₂—LiI, Li₂S—SiS₂—P₂S₅—LiI, Li₂S—B₂S₃, LiS—P₂S₅—ZₘSₙ (m and n being positive numbers, and Z being one of Ge. Zn and Ga), Li₂S—GeS₂, Li₂S—SiS₂—Li₆PO₄, Li₂S—SiS₂-LiₓMO_{y} (x and y being positive numbers, and M being one of P, Si, Ge, B, Al, Ga and In), Li₁₀GeP₂S₁₂, or the like. The first solid electrolyte 311 may be the same as or different from the solid electrolyte included in the first electrode 10 and/or the second electrode 20.

The first binder may include one or more selected from the group consisting of nitrile butadiene rubber (NBR), hydrogenated nitrile butadiene rubber (HNBR), styrene butadiene rubber (SBR), butadiene rubber (BR), polyvinylidene fluoride (PVDF), and polytetrailuoroethylene (PTFE). The first binder may be the same as or different from the binder included in the first electrode 10 and/or the second electrode 20.

The first dispersant may include an acrylate-based dispersant, a cellulose-based dispersant, a glycol-based dispersant, an ether-based dispersant, an ester-based dispersant, or the like, and concretely, may include at least one selected from the group consisting of carboxymethyl cellulose, carboxyethyl cellulose, polypropylene glycol, and combinations thereof.

The first solvent is not limited to a specific solvent, and may include any solvent which may disperse the first solid electrolyte 311, the first binder, and the first dispersant without causing side reactions therewith. The first solvent preferably includes a non-polar solvent. The first solvent may include at least one selected from the group consisting of N-methyl-2-pyrrolidone (NMP), butyl butyrate, pentyl butyrate, hexyl butyrate, heptyl butyrate, and combinations thereof.

The first electrolyte composition may include an amount of about 30 wt % to 60 wt % of the first solid electrolyte 311, an amount of about 1 wt % to 10 wt % of the first binder, an amount of about 1 wt % to 10 wt % of the first dispersant, and an amount of about 30 wt % to 60 wt % of the first solvent, based on the total weight of the first electrolyte composition.

The first electrolyte composition may have a solid content of about 40% to 70%. When the solid content deviates from the above range, it may be difficult to confirm dispersion characteristics.

The first electrolyte composition may have a turbiscan stability index (TSI) of about 1 or less when the first electrolyte composition is left unattended for 48 hours. The TSI may be measured using a turbiscan. The turbiscan is an optical analyzer which analyzes properties and physiochemical characteristics of samples using the transmission of light generated from a light source and the intensity of scattered light. Concretely, light generated from the light source is radiated to a cylindrical glass vial having a designated height in which a sample is contained, a transmission detector and a backscattering detector measure the intensities of transmitted light and scattered light, and then, the turbiscan stability index (TSI) of the sample may be calculated through Equation 1 below.

$$TSI = {\sum }_{i = 1}^{n} \frac{{\sum }_{h} \vert {scan}_{i} ( h ) - {scan}_{i - 1} ( h ) \vert}{H} \qquad [ Equation 1 ]$$

In Equation 1, i indicates the number of scans, H indicates the total height of the sample, h indicates a scan height, and scan₀(h) indicates the intensity (BS(%)) of backscattered light at the initial time.

As the TSI of the sample decreases, the stability and uniformity of the sample are improved.

In order to implement the above-described distribution of the first solid electrolyte 311 in the first layer 31, the first solid electrolyte 311 must be distributed to be mainly located in the lower region of the first electrolyte composition. The first electrolyte composition having the above-described distribution of the first solid electrolyte 311 may satisfy Requirement 1 below.

$$1 \leq \vert \frac{a}{b} \vert \qquad [ Requirement 1 ]$$

In Requirement 1, a may be the maximum value of variations of backscattering ΔBS in an area in which the scan height is in the range of 0% to 49%, as the results of measurement of the intensities of transmitted light and the scattered light by radiating near infrared light (1480 nm) to the first electrolyte composition left unattended for 48 hours.

In Requirement 1, b may be the maximum value of variations of backscattering ΔBS in an area in which the scan height is in the range of 51% to 100%, as the results of measurement of the intensities of the transmitted light and the scattered light by radiating near infrared light (X=880 nm) to the first electrolyte composition left unattended for 48 hours. The scan height may indicate, on the assumption that the total height of a sample stored in a container is 100%, a ratio of the height of a scan point to the total height. The scan point may indicate a position to which light generated from the light source is radiated.

Requirement 1 may be acquired from results obtained using the turbiscan.

The turbiscan stability index (TSI) of the first electrolyte composition and the above Requirement 1 will be described concretely with reference to Manufacturing Example 1 below.

The second layer 32 may include the first solid electrolyte 321, a second binder, and a second dispersant. Concretely, the second layer 32 may include an amount of about 1 wt % to 10 wt % of the second binder, an amount of about 0.1 wt % to 5 wt % of the second dispersant, and the balance of the second solid electrolyte 321, based on the total weight of the second layer 32.

The second electrolyte composition may include the second solid electrolyte 321, the second binder, the second dispersant, and a second solvent.

The second solid electrolyte 321 may include a sulfide-based solid electrolyte. The sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S—LiI, Li₂S—SiS₂—P₂S₅—LiI, Li₂S—B₂S₃, Li₂S—P₂S₅—ZₘSₙ (m and n being positive numbers, and Z being one of Ge, Zn and Ga), Li₂S—GeS₂, Li₂S—SiS₂—Li₃PO₄, Li₂S—SiS₂-LiₓMO_{y} (x and y being positive numbers, and M being one of P, Si, Ge, B, Al, Ga and In), Li₁₀GeP₂S₁₂, or the like. The second solid electrolyte 321 may be the same as or different from the first solid electrolyte 311 or the solid electrolyte included in the first electrode 10 and/or the second electrode 20.

The second binder may include at least one selected from the group consisting of nitrile butadiene rubber (NBR), hydrogenated nitrile butadiene rubber (HNBR), styrene butadiene rubber (SBR), butadiene rubber (BR), polyvinylidene fluoride (PVDF), polytetrafluoroethylene (PTFE), and combinations thereof. The second binder may be the same as or different from the first binder or the binder included in the first electrode 10 and/or the second electrode 20.

The second dispersant may include an acrylate-based dispersant, a cellulose-based dispersant, a glycol-based dispersant, an ether-based dispersant, an ester-based dispersant, or the like, and concretely, may include at least one selected from the group consisting of carboxymethyl cellulose, carboxyethyl cellulose, polypropylene glycol, and combinations thereof. The second dispersant may be the same as or different from the first dispersant.

The second solvent is not limited to a specific solvent, and may include any solvent which may disperse the second solid electrolyte 321, the first binder, and the first dispersant without causing side reactions therewith. The second solvent preferably includes a non-polar solvent. The second solvent may include at least one selected from the group consisting of N-methyl-2-pyrrolidone (NMP), butyl butyrate, pentyl butyrate, hexyl butyrate, heptyl butyrate, and combinations thereof. The second solvent may be the same as or different from the first solvent.

The second electrolyte composition may include an amount of about 30 wt % to 60 wt % of the second solid electrolyte 321, an amount of about 1 wt % to 10 wt % of the second binder, an amount of about 1 wt % to 10 wt % of the second dispersant, and an amount of about 30 wt % to 60 wt % of the second solvent, based on the total weight of the second electrolyte.

The second electrolyte composition may have a solid content of about 40% to 70%. When the solid content deviates from the above range, it may be difficult to confirm dispersion characteristics.

The second electrolyte composition may have a turbiscan stability index (TSI) of about 1 or less when the second electrolyte composition is left unattended for 48 hours.

In order to implement the above-described distribution of the second solid electrolyte 321 in the second layer 32, the second solid electrolyte 321 must be distributed to be mainly located in the upper region of the second electrolyte composition. The second electrolyte composition having the above-described distribution of the second solid electrolyte 321 may satisfy Requirement 2 below.

$$\vert \frac{c}{d} \vert < 1 \qquad [ Requirement 2 ]$$

In Requirement 2, c may be the maximum value of variations of backscattering ΔBS in an area in which the scan height is in the range of 0% to 49%, as the results of measurement of the intensities of transmitted light and the scattered light by radiating near infrared light (λ=880 nm) to the second electrolyte composition left unattended for 48 hours.

In Requirement 2, d may be the maximum value of variations of backscattering ΔBS in an area in which the scan height is in the range of 51% to 100%, as the results of measurement of the intensities of the transmitted light and the scattered light by radiating near infrared light (λ=880 nm) to the second electrolyte composition left unattended for 48 hours.

The turbiscan stability index (TSI) of the second electrolyte composition and the above Requirement 2 will be described concretely with reference to Manufacturing Example 2 below.

A method of manufacturing the all-solid-state battery 100 according to the present disclosure may include forming the first layer 31 by applying the first electrolyte composition to the first electrode 10, forming the second layer 32 by applying the second electrolyte composition to the first layer 31, and forming the second electrode 20 on the second layer 32.

The first solid electrolyte 311 is mainly located in the lower region of the first electrolyte composition, and thus, the surface of the first layer 31 facing the first electrode 10 is stably formed based on the all-solid-state battery 100 having a stack structure shown in FIG. 1. Therefore, pores or cracks do not occur on the surface of the first layer 31, and problems, such as concentration of current density, growth of lithium dendrites, etc., do not arise.

The second solid electrolyte 321 is mainly located in the upper region of the second electrolyte composition, and thus, the surface of the second layer 32 facing the second electrode 20 is stably formed based on the all-solid-state battery 100 having the stack structure shown in FIG. 1.

Further, the first electrolyte composition and the second electrolyte composition are intermixed with each other at the interface between the first layer 31 and the second layer 32, and thus, the inside of the solid electrolyte layer 30 may form a very stable state.

### EXAMPLE

Hereinafter, the present disclosure will be described in more detail through the following examples. The following examples serve merely to exemplarily describe the present disclosure, and are not intended to limit the scope of the invention.

### Manufacturing Example 1—Manufacture of First Electrolyte Composition

Li₆PS₅Cl was used as a first solid electrolyte. Butadiene rubber was used as a first binder. Polypropylene glycol having a number average molecular weight (Mn) of about 1,500 g/mol was used as a first dispersant. Butyl butyrate was used as a first solvent.

A first electrolyte composition was prepared by putting 94 wt % of the first solid electrolyte, 5 wt % of the first binder, and 1 wt % of the first dispersant into the first solvent so that the solid content of the first electrolyte composition was about 55%.

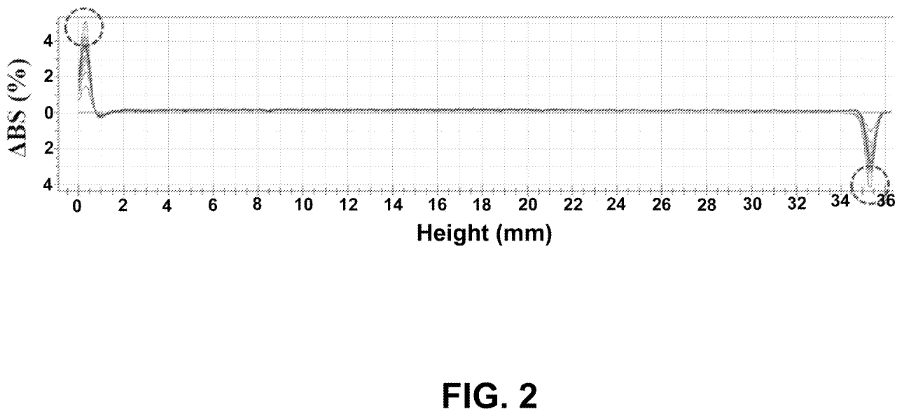

The first electrolyte composition was injected into a cylindrical glass vial having a thickness of 70 mm to a height of about 40 mm, and was left unattended for 48 hours, and the glass vial is mounted in a turbiscan. A light source was operated to radiate light of near infrared light (λ=880 nm) to the glass vial at intervals of about 40 μm in the height direction of the glass vial A transmission detector located opposite to the light source and a backscattering detector located at an angle of 40° with the light source measured the intensities of transmitted light and scattered light. The results of measurement are shown in FIG. 2. ΔBS may indicate variations of the intensity of the backscattered light.

Referring to FIG. 2, the maximum value a of variations of backcattering ΔBS in an area in which the scan height is in the range of 0% to 49% is about 3.6, and the maximum value b of variations of backscattering ΔBS in an area in which the scan height is in the range of 51% to 100% is about 2.8. Therefore, |a/b| of the first electrolyte composition was about 1.3, and thus satisfied Requirement 1 below.

$$1 \leq \vert \frac{a}{b} \vert \qquad [ Requirement 1 ]$$

The dispersion state of the first electrolyte composition was very stable from the fact that profiles measured at most scan points overlap each other without changes, as shown in FIG. 2. The turbiscan stability index (TSI) of the first electrolyte composition calculated through the above-described Equation 1 was also about 0.6.

### Manufacturing Example 2—Manufacture of Second Electrolyte Composition

Li₆PS₅Cl was used as a second solid electrolyte. Butadiene rubber was used as a second binder. Polypropylene glycol was used as a second dispersant. Butyl butyrate was used as a second solvent. A polypropylene glycol product having a different molecular weight from the polypropylene glycol product used as the first dispersant of Example 1 was used as the second dispersant so that the dispersion position of the second solid electrolyte was adjusted. Concretely, polypropylene glycol having a number average molecular weight (Mn) of about 500 g/mol was used as the second dispersant.

A second electrolyte composition was prepared by putting 94 wt % of the second solid electrolyte, 5 wt % of the second binder, and 1 wt % of the second dispersant into the second solvent so that the solid content of the second electrolyte composition was about 55%.

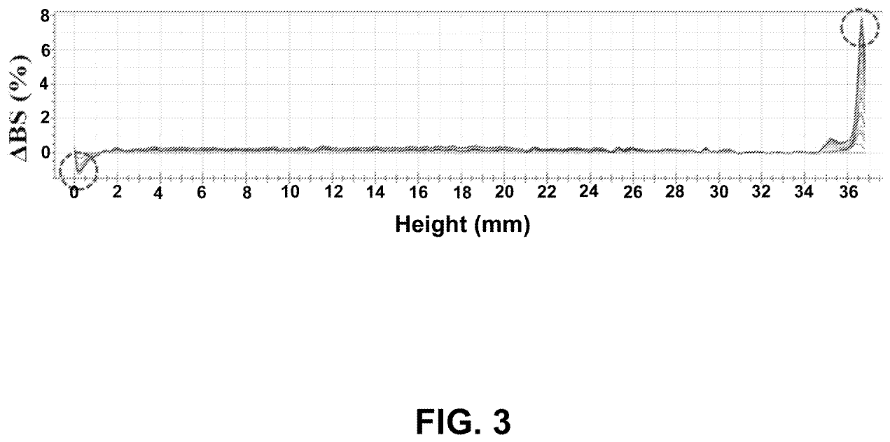

The intensities of transmitted light and scattered light of the second electrolyte composition were measured using the turbiscan by the same method as in Manufacturing Example 1. The results of measurement are shown in FIG. 3.

As shown in FIG. 3, the maximum value c of variations of backscattering ΔBS in an area in which the scan height is in the range of 0% to 49% was about 1.1, and the maximum value d of variations of backscattering ΔBS in an area in which the scan height is in the range of 51% to 100% was about 7. Therefore, |c/d| of the second electrolyte composition was about 0.2, and thus satisfied Requirement 2 below.

$$\vert \frac{c}{d} \vert < 1 \qquad [ Requirement 2 ]$$

Further, the dispersion state of the second electrolyte composition was very stable from the fact that profiles measured at most scan points overlap each other without changes, as shown in FIG. 3. The turbiscan stability index (TSI) of the second electrolyte composition calculated through the above-described Equation 2 was about 0.58.

### Example

A first layer was formed by applying the first electrolyte composition of Manufacturing Example 1 to a first electrode to a designated height. A second layer was formed by applying the second electrolyte composition of Manufacturing Example 2 to a first layer to a designated height. An all-solid-state battery was manufactured by adhering a second electrode to the second layer.

### Comparative Example

A first layer was formed by applying the first electrolyte composition of Manufacturing Example 1 to a first electrode to a designated height. An additional first layer was formed by applying the first electrolyte composition of Manufacturing Example 1 to the first layer to a designated height. The additional first layer was formed to have the same thickness as the second layer of Example 1. An all-solid-state battery was manufactured by adhering a second electrode to the additional first layer.

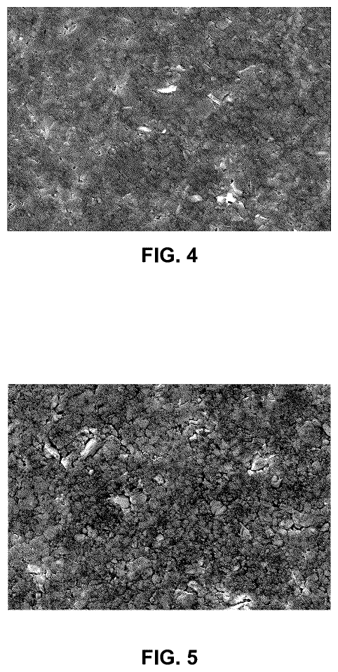

FIG. 4 shows the surface of the second layer according to Example analyzed by a scanning electron microscope. FIG. 5 shows the surface of the additional first layer according to Comparative Example analyzed by the scanning electron microscope. As shown in FIG. 5, many pores were formed on the surface of the additional first layer according to Comparative Example. On the other hand, as shown in FIG. 4 the surface of the second layer according to Example was very smooth and pores formed thereon were remarkably reduced compared to Comparative Example.

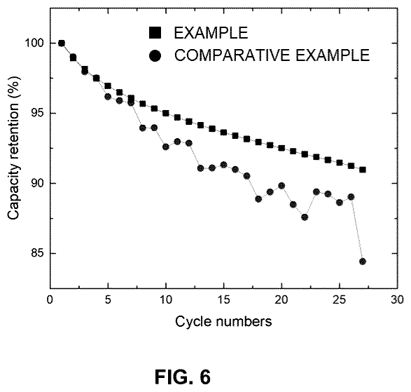

FIG. 6 shows the capacity retentions of the all-solid-state batteries according to Example and Comparative Example. The capacity retention of the all-solid-state battery according to Comparative Example was sharply reduced after about the 5^{th} charge cycle compared to the all-solid-state battery according to Example.

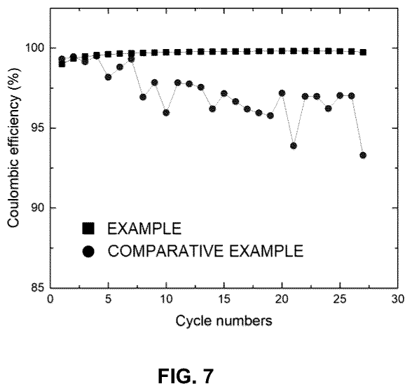

FIG. 7 shows the Coulombic efficiencies of the all-solid-state batteries according to Example and Comparative Example. The all-solid-state battery according to Example exhibited Columbic efficiency of about 100% even after the 25^{th} charge cycle, but the all-solid-state battery according to Example exhibited very irregular and unstable Columbic efficiency.

According to various exemplary embodiments of the present disclosure, an all-solid-state battery having uniform interfaces between a solid electrolyte layer and electrodes may be provided.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. An all-solid-state battery comprising:
a first electrode;
a second electrode; and
a solid electrolyte layer interposed between the first electrode and the second electrode,
wherein the solid electrolyte layer comprises:
a first layer disposed on the first electrode and comprising a first solid electrolyte; and
a second layer disposed on the second electrode and comprising a second solid electrolyte.

2. The all-solid-state battery of claim 1, wherein the first layer comprises a first electrolyte composition comprising the first solid electrolyte, a first binder and a first dispersant.

3. The all-solid-state battery of claim 1, wherein the first solid electrolyte comprises a sulfide-based solid electrolyte.

4. The all-solid-state battery of claim 2, wherein the first binder comprises one or more selected from the group consisting of nitrile butadiene rubber (NBR), hydrogenated nitrile butadiene rubber (HNBR), styrene butadiene rubber (SBR), butadiene rubber (BR), polyvinylidene fluoride (PVDF), and polytetrafluoroethylene (PTFE).

5. The all-solid-state battery of claim 2, wherein the first dispersant comprises one or more selected from the group consisting of carboxymethyl cellulose, carboxyethyl cellulose, and polypropylene glycol.

6. The all-solid-state battery of claim 2, wherein the first layer is formed by applying the first electrolyte composition,
the first electrolyte composition further comprises a first solvent, and
the first solvent comprises one or more selected from the group consisting of N-methyl-2-pyrrolidone (NMP), butyl butyrate, pentyl butyrate, hexyl butyrate, and heptyl butyrate.

7. The all-solid-state battery of claim 2, wherein the first electrolyte composition has a solid content of about 40% to 70%.

8. The all-solid-state battery of claim 2, wherein the first electrolyte composition has a turbiscan stability index (TSI) of about 1 or less when the first electrolyte composition is left unattended for 48 hours.

9. The all-solid-state battery of claim 2, wherein the first electrolyte composition satisfies Requirement 1 below,
$$1 \leq \vert \frac{a}{b} \vert , \qquad [ Requirement 1 ]$$
wherein:
a is a maximum value of variations of backscttering (ΔBS) in an area configured such that a scan height is in a range of about 0% to 49%, as results of measurement of intensities of transmitted light and the scattered light by radiating near infrared light having a wavelength of 880 nm to the first electrolyte composition left unattended for 48 hours; and
b is a maximum value of variations of backcattering (ΔBS) in an area configured such that the scan height is in a range of about 51% to 100%, as the results of measurement of the intensities of the transmitted light and the scattered light by radiating the near infrared light having the wavelength of 880 nm to the first electrolyte composition left unattended for 48 hours.

10. The all-solid-state battery of claim 1, wherein the second layer comprises a second electrolyte composition comprising the second solid electrolyte, a second binder, a second dispersant, and a second solvent.

11. The all-solid-state battery of claim 1, wherein the second solid electrolyte comprises a sulfide-based solid electrolyte.

12. The all-solid-state battery of claim 10, wherein the second binder comprises one or more selected from the group consisting of nitrile butadiene rubber (NBR), hydrogenated nitrile butadiene rubber (HNBR), styrene butadiene rubber (SBR), butadiene rubber (BR), polyvinylidene fluoride (PVDF), and polytetrafluoroethylene (PTFE).

13. The all-solid-state battery of claim 10, wherein the second dispersant comprises one or more selected from the group consisting of carboxymethyl cellulose, carboxyethyl cellulose, and polypropylene glycol.

14. The all-solid-state battery of claim 10, wherein the second layer is formed by applying the second electrolyte composition,
the second electrolyte composition further comprises a second solvent, and
the second solvent comprises one or more selected from the group consisting of N-methyl-2-pyrrolidone (NMP), butyl butyrate, pentyl butyrate, hexyl butyrate, and heptyl butyrate.

15. The all-solid-state battery of claim 10, wherein the second electrolyte composition has a solid content of about 40% to 70%.

16. The all-solid-state battery of claim 10, wherein the second electrolyte composition has a turbiscan stability index (TSI) of about 1 or less when the second electrolyte composition is left unattended for 48 hours.

17. The all-solid-state battery of claim 10, wherein the second electrolyte composition satisfies Requirement 2 below,
$$\vert \frac{c}{d} \vert < 1 , \qquad [ Requirement 2 ]$$
wherein:
c is a maximum value of variations of backscattering (ΔBS) in an area configured such that a scan height is in a range of 0% to 49%, as results of measurement of intensities of transmitted light and the scattered light by radiating near infrared light having a wavelength of 880 nm to the second electrolyte composition left unattended for 48 hours; and
d is a maximum value of variations of backcattering (ΔBS) in an area configured such that the scan height is in a range of 51% to 100%, as the results of measurement of the intensities of the transmitted light and the scattered light by radiating the near infrared light having the wavelength of 880 nm to the second electrolyte composition left unattended for 48 hours.

18. The all-solid-state battery of claim 1, wherein:
the first layer comprises a first dispersant, and the second layer comprises a second dispersant; and
a number average molecular weight of the first dispersant is greater than a number average molecular weight of the second dispersant.

19. A vehicle comprising an all-solid-state battery of claim 1.
